(19) United States
(12) Patent Application Publication
(10) Pub. No.: US 2012/0193544 A1
(43) Pub. Date: Aug. 2, 2012

(54) RADIOLOGICAL IMAGE DETECTION APPARATUS

(75) Inventors: Yasuhisa KANEKO, Kanagawa (JP); Haruyasu NAKATSUGAWA, Kanagawa (JP)

(73) Assignee: FUJIFILM CORPORATION, Tokyo (JP)

(21) Appl. No.: 13/339,012

(22) Filed: Dec. 28, 2011

(30) Foreign Application Priority Data
Jan. 31, 2011 (JP) 2011-019326

(51) Int. Cl. G01T 1/20

(52) U.S. Cl. 250/369

(57) ABSTRACT

A radiological image detection apparatus includes: a substrate in which a recess portion having a bottom portion including at least the whole of a radiological imaging region is formed; a phosphor which contains a fluorescent material emitting fluorescence when exposed to radiation and which is provided in the recess portion of the substrate; a group of photoelectric conversion elements which are provided on an opposite side to the recess portion provided with the phosphor and which photoelectrically convert the fluorescence emitted from the phosphor; a support which supports the phosphor; and a fixing portion which fixes the support and the substrate. The photoelectric conversion elements, the substrate, the phosphor and the support are arranged in ascending order of distance from a radiation entrance side.

### CROSS-REFERENCE TO RELATED APPLICATIONS

This application is based on and claims priority under 35 USC 119 from Japanese Patent Application No. 2011-019326 filed on Jan. 31, 2011; the entire content of which is incorporated herein by reference.

### BACKGROUND

1. Technical Field

The present invention relates to a radiological image detection apparatus.

2. Related art

In recent years, a radiological image detection apparatus using an FPD (Flat Panel Detector) for detecting a radiological image to generate digital image data has been put to practical use, and has been popular rapidly because it can confirm the image more instantly than a background-art imaging plate. There are various systems in the radiological image detection apparatus. An indirect conversion system has been known as one of the systems.

A radiological image detection apparatus of an indirect conversion system has a radiological image conversion panel and a sensor panel. The radiological image conversion panel has a scintillator formed out of a fluorescent material such as CsI or GOS (Gd₂O₂S) which emits fluorescence when exposed to radiation. The sensor panel has a two-dimensional array of photoelectric conversion elements. Typically, the scintillator is provided in tight contact with the two-dimensional array of the photoelectric conversion elements. Radiation transmitted through a subject is once converted into fluorescence by the scintillator of the radiological image conversion panel. The fluorescence from the scintillator is photoelectrically converted by the group of the photoelectric conversion elements of the sensor panel to generate an electric signal (digital image data).

In the radiological image detection apparatus of the indirect conversion system, a so-called ISS (Irradiation Side Sampling) radiological image detection apparatus in which radiation is made incident from the sensor panel side has been also proposed (e.g. see Patent Document 1 (JP-A-2011-017683), Patent Document 2 (JP-A-6-140613) and Patent Document 3 (JP-A-2005-203708)).

Particularly in a radiological image detection apparatus according to Patent Document 2, radiation is made incident from the back side of a substrate including a sensor panel provided with photoelectric conversion elements, so that radiation once transmitted through the sensor panel can be converted into fluorescence by a scintillator. In the radiological image detection apparatus, a recess portion is provided in a portion corresponding to a radiological imaging region of the sensor panel to restrain the substrate of the sensor panel from absorbing the radiation.

In the radiological image detection apparatus according to Patent Document 2, the thickness of the substrate including the sensor panel is indeed reduced, but the scintillator is not provided in the recess portion of the substrate. Therefore, formation of the radiological image detection apparatus as a whole into a thin plate cannot be achieved.

On the other hand, in a radiological image detection apparatus according to Patent Document 3, a scintillator is provided in a recess portion of a substrate.

However, each of Patent Documents 2 and 3 merely discloses a radiological image detection apparatus for converting radiation into digital image data using a solid-state image sensor such as a CCD image sensor. A DR (Digital Radiography) cassette as an example of a radiological image detection apparatus using an FPD is generally mounted with various electronic components such as a TFT layer, a driving circuit, etc. Therefore, the DR cassette is much larger than the radiological image detection apparatus disclosed in Patent Document 2 or 3.

If the idea that a recess portion is provided in a substrate as disclosed in Patent Document 3 is applied to a large-size radiological image detection apparatus such as a cassette, there will arise a problem about shock resistance conspicuously.

For example, a large-size radiological image detection apparatus may use a glass substrate as a substrate of a sensor panel. The glass substrate is poor at heat conduction so that the adhesion between the glass substrate and a scintillator is poor. Accordingly, when the scintillator is deposited directly on a recess portion of the glass substrate, there is a fear that the scintillator may be separated from the glass substrate due to the scintillator' s own weight. Further, since the substrate is thinned due to the recess portion provided in the substrate, there is another fear that the substrate may be deformed.

When the scintillator is deposited directly on the recess portion of the substrate, there arises another problem about falling-down of the radiological image detection apparatus. This is because the scintillator may be separated from the substrate due to the impact given to the radiological image detection apparatus when the radiological image detection apparatus falls down.

On the other hand, there is a method in which an adhesive portion is provided between a bottom surface of the recess portion of the substrate and the scintillator so as to deposit the scintillator indirectly. However, radiation or fluorescence emitted from the scintillator must be transmitted not only through the substrate but also through the adhesive portion. Although provision of the recess portion in the substrate avoids the lowering of sensitivity, there still occurs a problem about the lowering of sensitivity. Further, in the case of indirect deposition, there is a possibility that the position of the scintillator may be displaced in the recess portion when the radiological image detection apparatus falls down. Since the scintillator is displaced thus, there is a possibility that the scintillator may touch the sensor board and be damaged.

### SUMMARY

An illustrative aspect of the invention is to enhance the shock resistance of a radiological image detection apparatus while suppressing the lowering of the sensitivity of the radiological image detection apparatus caused by a substrate.

According to an aspect of the invention, a radiological image detection apparatus including: a first substrate in which a recess portion having a bottom portion including at least the whole of a radiological imaging region is formed; a phosphor which contains a fluorescent material emitting fluorescence when exposed to radiation and which is provided in the recess portion of the first substrate; a group of photoelectric conversion elements which are provided on an opposite side to the recess portion provided with the phosphor and which photoelectrically convert the fluorescence emitted from the phosphor; a support which supports the phosphor; and a fixing portion which fixes the support and the first substrate; wherein: the photoelectric conversion elements, the first substrate, the phosphor and the support are arranged in ascending order of distance from a radiation entrance side.

With the configuration of the radiological detection apparatus, the phosphor is provided in the recess portion of the substrate, so that the support can support the phosphor to improve the shock resistance while the lowering of sensitivity caused by the substrate is suppressed.

### BRIEF DESCRIPTION OF THE DRAWINGS

FIG. 1 is a view schematically showing the configuration of an example of a radiological image detection apparatus for explaining an embodiment of the invention.

FIG. 2 is a view schematically showing the configuration of a substrate of the radiological image detection apparatus in FIG. 1.

FIGS. 3A-3B are views schematically showing the configuration of a phosphor used in the radiological image detection apparatus in FIG. 1.

FIG. 4 is a sectional view of the phosphor taken on line IV-IV in FIG. 3A.

FIG. 5 is a sectional view of the phosphor taken on line V-V in FIG. 3A.

FIGS. 6A-6B are views schematically showing the configuration of another example of the radiological image detection apparatus in FIG. 1.

### DETAILED DESCRIPTION

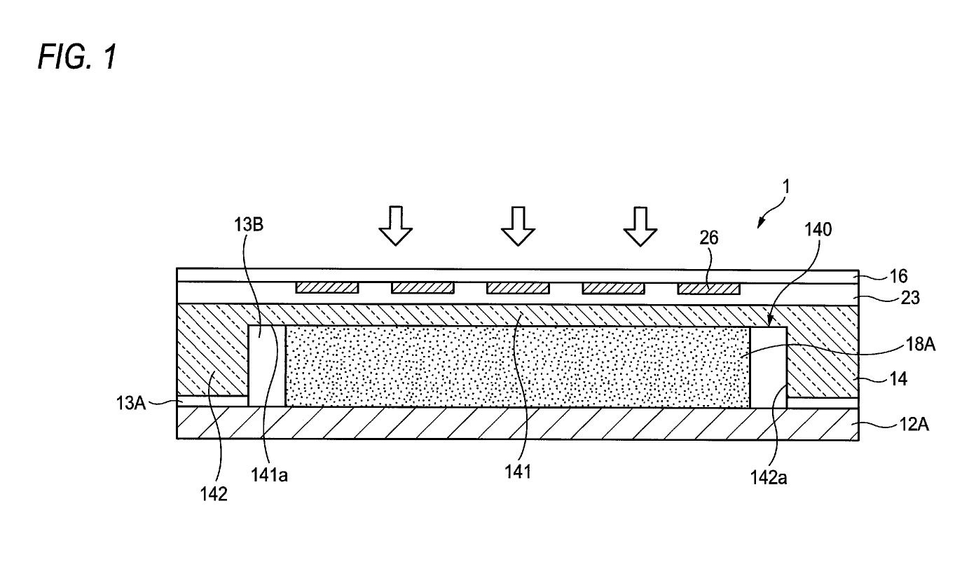

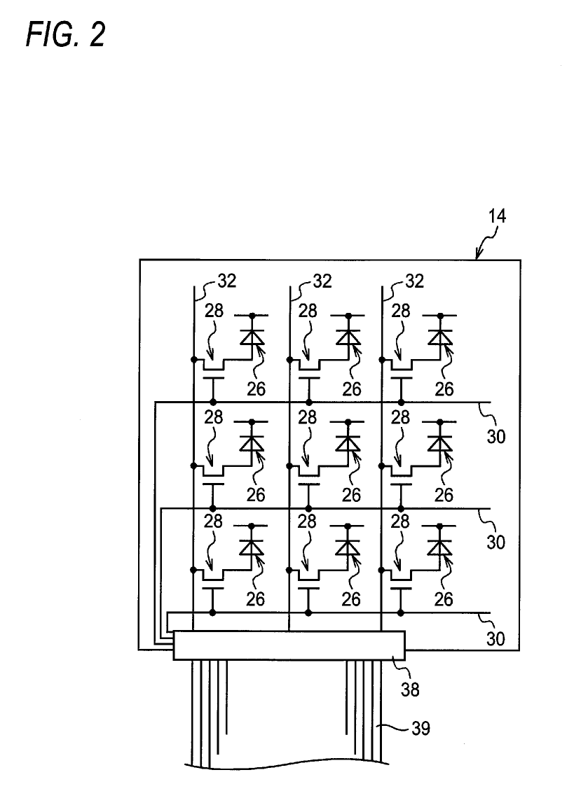

FIG. 1 is a view schematically showing the configuration of an example of a radiological image detection apparatus for explaining an embodiment of the invention. FIG. 2 is a view schematically showing the configuration of a substrate of the radiological image detection apparatus in FIG. 1.

The radiological image detection apparatus 1 has a TFT (Thin Film Transistor) layer 16, a flattening layer 23, a reception substrate 14, a scintillator (phosphor) 18A and a support substrate 12A. Switching devices 28 consisting of TFTs are formed in the TFT layer 16. The flattening layer 23 includes photoelectric conversion elements 26 arrayed two-dimensionally. The reception substrate 14 has a recess portion 140. The scintillator 18A contains a fluorescent material which is received in the recess portion 140 of the reception substrate 14, and which emits fluorescence when exposed to radiation. The support substrate 12A supports the scintillator 18A.

In this example, radiation is radiated from the TFT layer 16 side, and transmitted through the TFT layer 16 and the photoelectric conversion elements 26. The radiation transmitted through the TFT layer 16 and the photoelectric conversion elements 26 is transmitted through a thin plate portion 141 which is a thin portion of the recess portion 140 in the reception substrate 14, and then made incident on the scintillator 18A. In response to the incident radiation, fluorescence is generated by the scintillator 18A. The fluorescence is transmitted through the thin plate portion 141 of the reception substrate 14 again. After that, the fluorescence is photoelectrically converted by the photoelectric conversion elements 26. Electric charges collected thus are then read out by the switching devices 28 provided in the TFT layer 16. In this manner, the photoelectric conversion elements 26 are provided on the radiation entrance side of the scintillator 18A generating plenty of fluorescence, and closely to the scintillator 18A through the thin plate portion 141 of the reception substrate 14. Thus, sensitivity is improved.

In this example, the TFT layer 16 is provided as another layer than the flattening layer 23. However, the switching devices 28 etc. provided in the TFT layer 16 may be provided in the same flattening layer 23 where the photoelectric conversion elements 26 are provided.

The support substrate 12A is a deposition substrate on which the scintillator 18A is deposited directly. The scintillator 18A is supported by the support substrate 12A from an opposite side to the radiation entrance direction. In addition, the support substrate 12A is provided to close the opening of the recess portion 140 of the reception substrate 14, so as to prevent the scintillator 18A from deliquescing due to external moisture and improve the sealing performance of the radiological image detection apparatus 1. Further, the support substrate 12A also contributes toward preventing the deformation of the reception substrate 14.

A carbon plate, CFRP (Carbon Fiber Reinforced Plastic) plate, a glass plate, a quartz substrate, a sapphire substrate, a metal sheet selected from iron, tin, chromium or aluminum, etc. may be used as the support substrate 12A. The support substrate 12A is not limited to the aforementioned ones, but any substrate may be used as long as the scintillator 18A can be formed thereon.

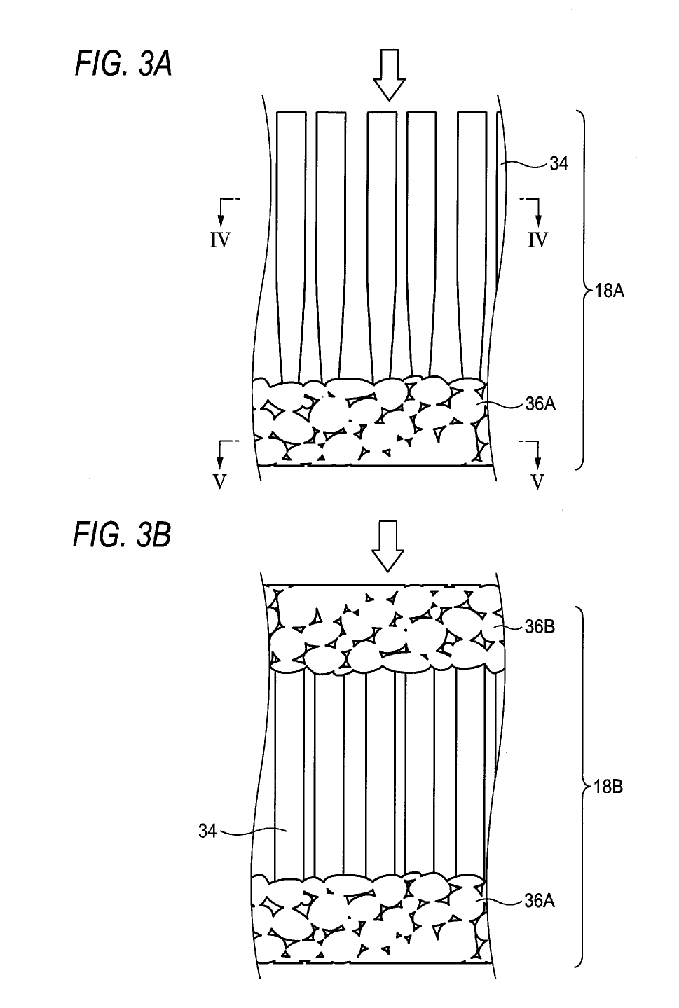

The scintillator 18A is formed by direct deposition on the support substrate 12A as described above. The scintillator 18A is constituted by a columnar portion 34 (see FIG. 3A) and a non-columnar portion 36A (see FIG. 3A). The columnar portion 34 is provided on the opposite side to the support substrate 12A, and the non-columnar portion 36A is provided on the support substrate 12A side. The columnar portion 34 and the non-columnar portion 36A are formed continuously to be laid on each other like layers on the support substrate 12A. For example, the columnar portion 34 and the non-columnar portion 36A may be formed by a vapor deposition method as will be described later in detail. The columnar portion 34 and the non-columnar portion 36A are formed out of one and the same fluorescent material, but the doping amount of an activator such as Tl in the columnar portion 34 may be different from that in the non-columnar portion 36A.

For example, CsI:Tl, NaI:Tl (thallium doped sodium iodide), CsI:Na (sodium doped cesium iodide), etc. can be used as the fluorescent materials forming the scintillator 18A. Of them, CsI:Tl is preferred because the emission spectrum thereof conforms to the maximum value (around 550 nm) of spectral sensitivity of an a-Si photodiode.

The columnar portion 34 is formed out of a group of columnar crystals in which crystals of the aforementioned fluorescent material have grown into columnar shapes. A plurality of neighbor columnar crystals may be coupled to form a columnar crystal. An air gap is put between adjacent columnar crystals, and any columnar crystal exists independently of one another.

The non-columnar portion 36A is formed out of a group of spherical crystals in which crystals of the fluorescent material have grown into substantially spherical shapes with comparatively small diameters. In the non-columnar portion 36A formed out of a group of spherical crystals, the crystals are irregularly coupled or laid on one another so that any distinct air gap cannot be produced among the crystals. The non-columnar portion 36A may include an amorphous substance of the aforementioned fluorescent material.

The reception substrate 14 includes the recess portion 140 which is formed out of a thin plate portion 141 and a thick plate portion 142. The reception substrate 14 is provided to enclose the scintillator 18A completely. The thin plate portion 141 is about 0.2 mm thick, and the thick plate portion 142 is about 0.7 mm thick.

A first adhesive portion 13A is provided between the support substrate 12A and the thick plate portion 142 of the reception substrate 14. The support substrate 12A and the reception substrate 14 are fixed by the first adhesive portion 13A. It is preferable that the adhesive agent used for the first adhesive portion 13A is a dismantlable adhesive agent whose adhesion property can be lowered by heat or the like. In the radiological image detection apparatus 1, the support substrate 12A and the reception substrate 14 are fixed by adhesive bonding. The fixing method is not limited thereto. Any method may be used as long as the support substrate 12A and the reception substrate 14 can be fixed by the method.

Each photoelectric conversion element 26 is provided on the opposite side to the recess portion 140 where the scintillator 18A is received. The photoelectric conversion element 26 is constituted by a photoconductive layer (not shown) and a pair of electrodes. After the fluorescence of the scintillator 18A is transmitted through the thin plate portion 141 of the reception substrate 14, the fluorescence is incident on the photoconductive layer. The photoconductive layer generates electric charges in response to the incident fluorescence. The electrodes are provided on front and back surfaces of the photoconductive layer. The electrode provided on the scintillator 18A side surface of the photoconductive layer is a bias electrode for applying a bias voltage to the photoconductive layer. The electrode provided on the opposite surface is a charge collection electrode for collecting electric charges generated by the photoconductive layer.

The photoelectric conversion elements 26 are formed in the flattening layer 23 which serves to improve the adhesion to the surface of the reception substrate 14. In addition, the reception substrate 14 and the flattening layer 23 are pasted to each other through an adhesive layer (not shown). The flattening layer 23 and the adhesive layer form a resin layer. Matching oil consisting of transparent liquid or gel, or the like, may be used as the resin layer. The resin layer is preferably not thicker than 50 μm, more preferably in a range of from 5 μm to 30 μm, in view of sensitivity and image sharpness.

The TFT layer 16 is formed on the photoelectric conversion elements 26. The TFT layer 16 includes the switching devices 28 consisting of TFTs (Thin Film Transistors) (see FIG. 2).

The switching devices 28 are arrayed two-dimensionally in the TFT layer 16 correspondingly to the two-dimensional array of the photoelectric conversion elements 26. The charge collection electrode of each photoelectric conversion element 26 is connected to corresponding one of the switching devices 28 of the TFT layer 16. Electric charges collected by the charge collection electrode are read out by the switching device 28.

As shown in FIG. 2, a plurality of gate lines 30 and a plurality of signal lines (data lines) 32 are provided in the TFT layer 16. The gate lines 30 are provided to extend in one direction (row direction) so as to turn on/off the switching devices 28 respectively. The signal lines 32 are provided to extend in a perpendicular direction (column direction) to the gate lines 30 so as to read out electric charges through the switching devices 28 which have been turned on. In addition, a connection terminal 38 to which the gate lines 30 and the signal lines 32 are connected individually is disposed in a circumferential edge portion of the reception substrate 14 provided with the TFT layer 16. The connection terminal 38 is connected to a circuit board (not shown) through a connection circuit 39 as shown in FIG. 2. The circuit board includes a gate line driver as an external circuit, and a signal processing portion.

The switching devices 28 are turned on sequentially row by row in accordance with signals supplied through the gate lines 30 from the gate line driver respectively. Electric charges read out by the switching devices 28 which have been turned on are transmitted as charge signals through the signal lines 32 and supplied to the signal processing portion. Thus, the electric charges are read out sequentially column by column, and converted into an electric signal in the signal processing portion so as to generate digital image data.

In this manner, the TFT layer 16, the photoelectric conversion elements 26, the reception substrate 14, the scintillator 18A and the support substrate 12A are arranged in ascending order of distance from the radiation entrance side, and the first adhesive portion 13A is provided between the thick plate portion 142 of the reception substrate 14 and the support substrate 12A.

Here, a second adhesive portion 13B for filling the space between the scintillator 18A and the reception substrate 14 is provided between a side surface of the scintillator 18A and a side surface 142a of the thick plate portion 142 of the recess portion 140 facing the scintillator 18A. In addition, the portion where the scintillator 18A faces the thin plate portion 141 of the recess portion 140 is not adhesively bonded, but the scintillator 18A and the thin plate portion 141 of the recess portion 140 contact each other directly. In other words, the second adhesive portion 13B is provided to surround only the side surface of the scintillator 18A.

Preferably, the second adhesive portion 13B has flexibility. In addition, the adhesive agent used as the second adhesive portion 13B is preferably a dismantlable adhesive agent, whose adhesion can be lowered by heat, ultraviolet rays, or the like. For example, a silicone-based adhesive agent may be used as the adhesive agent of the second adhesive portion 13B, but the adhesive agent is not limited thereto.

A shock absorbing material (having a shock absorbing property) for absorbing shock against the radiological image detection apparatus 1 may be provided in place of the second adhesive portion 13B. Due to filling with the shock absorbing material, the scintillator 18A can be removed easily to improve the reworkability while securing the shock resistance.

FIGS. 3A-3B are views schematically showing the configuration of the phosphor used in the radiological image detection apparatus in FIG. 1. Incidentally, arrows in FIGS. 3A and 3B indicate a radiation entrance direction.

As shown in FIG. 3A, in the scintillator 18A used in the radiological image detection apparatus 1, an opposite surface of the scintillator 18A to the support substrate 12A, that is, a front end of each columnar crystal of the columnar portion 34 is opposed to a bottom surface 141a of the thin plate portion 141. That is, the columnar portion 34 consisting of a group of columnar crystals is disposed on the radiation entrance side of the scintillator 18A.

Fluorescence generated in each columnar crystal of the columnar portion 34 is totally reflected in the columnar crystal repeatedly due to a difference in refractive index between the columnar crystal and a gap (air) surrounding the columnar crystal, so as to be restrained from being diffused. Thus, the fluorescence is guided to the photoelectric conversion elements 26 through the reception substrate 14 opposed to the columnar crystal. Thus, the sharpness of the image is improved.

Of the fluorescence generated in each columnar crystal of the columnar portion 34, fluorescence travelling on the opposite side to the bottom surface 141a of the thin plate portion 141, that is, toward the support substrate 12A, is reflected toward the photoelectric conversion elements 26 in the non-columnar portion 36A. Thus, the utilization efficiency of the fluorescence is enhanced to improve the sensitivity. In addition, since the non-columnar portion 36A is deposited on the support substrate 12A, the scintillator 18A is fixed firmly to the support substrate 12A. Thus, the shock resistance is improved.

In addition, the non-columnar portion 36A is formed out of small-diameter spherical crystals or an aggregate thereof. Individual air gaps are comparatively small. The non-columnar portion 36A is denser than the columnar portion 34 and lower in void ratio. Due to the non-columnar portion 36A interposed between the support substrate 12A and the columnar portion 34, the adhesion between the support substrate 12A and the scintillator 18A is improved. As a result, the resistance against stress acting due to warp or impact caused by a difference in thermal expansion between the support substrate 12A and the TFT layer 16 is improved so that the scintillator 18A can be prevented from being separated from the support substrate 12A.

As shown in FIG. 3B, a scintillator 18B may be used in place of the scintillator 18A in the radiological image detection apparatus 1. In the scintillator 18B, another non-columnar portion 36B is further provided on the columnar portion 34 of the scintillator 18A shown in FIG. 3A.

The non-columnar portion 36B is formed out of small-diameter spherical crystals or an aggregate thereof, and the non-columnar portion 36B is denser and lower in void ratio than the columnar portion 34. Particularly in order to suppress the function of optical reflection as much as possible, it is preferable that the void ratio is substantially zero. Due to the non-columnar portion 36B provided thus, it is possible to lower the possibility that the columnar portion 34 may be damaged by contact with the bottom surface 141a of the thin plate portion 141. Thus, the shock resistance of the radiological image detection apparatus 1 can be improved.

An optically transparent shock absorbing layer may be provided in place of the non-columnar portion 36B. Transparent thin-film silicone rubber about 20 μm thick may be used as the shock absorbing layer. When the shock absorbing layer is provided thus, it is possible to more suppress image blurring while ensuring the shock resistance of the radiological image detection apparatus 1.

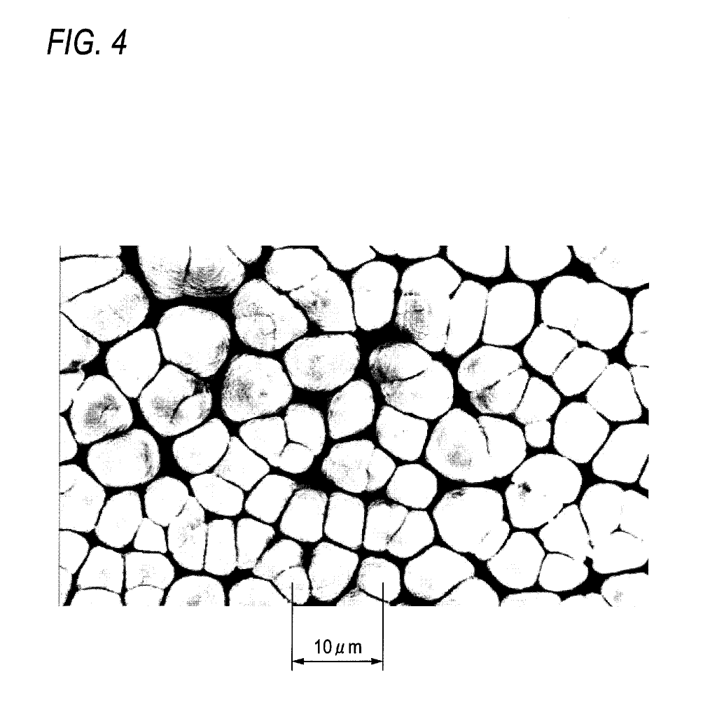

FIG. 4 is a sectional view of the phosphor taken on line IV-IV in FIG. 3A.

As is apparent from FIG. 4, it can be known that, in the columnar portion 34, the columnar crystals show substantially uniform sectional diameters in the growth directions of the crystals, and have gaps around the columnar crystals so that the columnar crystals exist independently of one another. From the point of view of light guide effect, mechanical strength and prevention of pixel defect, it is preferable that the crystal diameter of each columnar crystal is not smaller than 2 μm and not larger than 8 μm. When the crystal diameter is too small, each columnar crystal is short of mechanical strength, and there is a fear that the columnar crystal may be damaged by impact or the like. When the crystal diameter is too large, the number of columnar crystals for each photoelectric conversion element 26 is reduced, and there is a fear of an increasing probability that the element may be defective when one of the crystals corresponding thereto is cracked.

Here, the crystal diameter designates the maximum diameter of a columnar crystal observed from above in the growth direction of the crystal. As a specific measurement method, the columnar diameter (crystal diameter) of each columnar crystal is measured by observation in an SEM (Scanning Electron Microscope) from a plane perpendicular to the thickness direction of the columnar crystal. In the observation, the scintillator is observed from its surface in the magnification (about 2,000 times) with which 100 to 200 columnar crystals can be observed in each shot. The maximum values of columnar diameters of all the columnar crystals taken in the shot are measured and averaged. A value obtained thus is used. The columnar diameters (μm) are calculated to two places of decimals, and the average value is rounded in the two places of decimals according to JIS Z 8401.

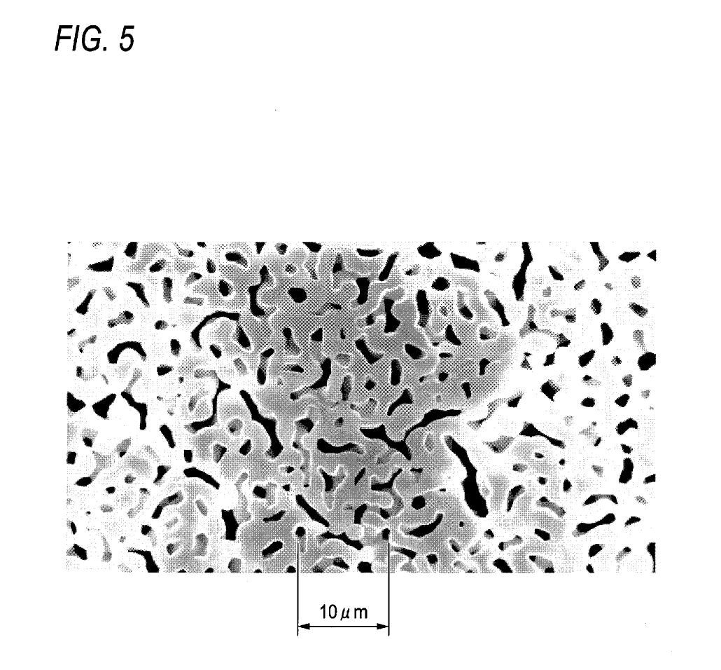

FIG. 5 is a sectional view of the phosphor taken on line V-V in FIG. 3A.

As is apparent from FIG. 5, in the non-columnar portion 36A, crystals are irregularly coupled or laid on one another so that any distinct air gap among the crystals cannot be recognized in comparison with the columnar portion 34. From the point of view of adhesion and optical reflection, it is preferable that the diameter of each crystal forming the non-columnar portion 36A is not smaller than 0.5 μm and not larger than 7.0 μm. When the crystal diameter is too small, the void ratio is close to zero, and there is a fear that the function of optical reflection may deteriorate. When the crystal diameter is too large, the flatness deteriorates, and there is a fear that the adhesion to the support substrate 12A may deteriorate. In addition, from the point of view of optical reflection, it is preferable that the shape of each crystal forming the non-columnar portion 36A is substantially spherical.

Here, when crystals are coupled with each other, the crystal diameter of each crystal is measured as follows. That is, a line obtained by connecting recesses (concaves) appearing between adjacent crystals is regarded as the boundary between the crystals. The crystals coupled with each other are separated to have minimum polygons. The columnar diameters and the crystal diameters corresponding to columnar diameters are measured thus. An average value of the crystal diameters is obtained in the same manner as the crystal diameter in the columnar portion 34. The average value obtained thus is used as the crystal diameter.

It is preferable that the thickness of the columnar portion 34 and the thickness of the non-columnar portion 36A are set so that the ratio (t2/t1) is not smaller than 0.01 and not larger than 0.25, more preferably not smaller than 0.02 and not larger than 0.1 when t1 designates the thickness of the columnar portion 34 and t2 designates the thickness of the non-columnar portion 36A. When the ratio (t2/t1) is in the aforementioned range, the fluorescent efficiency, the optical diffusion prevention and the optical reflection can be set in suitable ranges to improve the sensitivity and the image sharpness.

In addition, the thickness t1 of the columnar portion 34 depends on the energy of radiation but is preferably not smaller than 200 μm and not larger than 700 μm in order to secure sufficient radiation absorption in the columnar portion 34 and sufficient image sharpness. When the thickness of the columnar portion 34 is too small, radiation cannot be absorbed sufficiently in the columnar portion 34 so that there is a fear that the sensitivity may deteriorate. When the thickness of the columnar portion 34 is too large, optical diffusion occurs so that there is a fear that the image sharpness may deteriorate in spite of the light guide effect of the columnar crystals.

The thickness T2 of the non-columnar portion 36A is preferably not smaller than 5 μm and not larger than 125 μm from the point of view of adhesion to the support substrate 12A and optical reflection. When the thickness of the non-columnar portion 36A is too small, there is a fear that sufficient adhesion to the support substrate 12A may not be obtained. When the thickness of the non-columnar portion 36A is too large, contribution of fluorescence in of the non-columnar portion 36A and diffusion due to optical reflection in the non-columnar portion 36A are increased so that there is a fear that the image sharpness may deteriorate.

Further, in the radiological image detection apparatus 1, the thickness distribution of the non-columnar portion 36A may be uneven. The columnar portion 34 and the non-columnar portion 36A are formed continuously out of crystals of the same fluorescent material. Accordingly, the bonding between the columnar portion 34 and the non-columnar portion 36A is stronger than the bonding between different kinds of materials, such as the bonding between the columnar portion 34 and the support substrate 12. Therefore, by making the thickness distribution of the non-columnar portion 36A uneven, resistance against stress in the bonding portion can be compensated.

It is preferable that the thickness of each part of the non-columnar portion 36A is distributed in the aforementioned range of being not smaller than 5 μm and not larger than 125 μm from the point of view of the adhesion to the support substrate 12A and the optical reflection. An uneven thickness distribution is set equally all over the non-columnar portion 36A. However, the non-columnar portion 36A may be sectioned into a plurality of regions. In that case, the unevenness (difference between maximum thickness and minimum thickness or deviation of thickness distribution) may differ from one region to another.

Next, description will be made on an example of the method for manufacturing the scintillator 18A of the aforementioned scintillators 18A and 18B.

The scintillator 18A is preferably formed directly on the surface of the support substrate 12A by a vapor deposition method. According to the vapor deposition method, the non-columnar portion 36A and the columnar portion 34 can be formed integrally and continuously in that order. Description will be made below in the case where CsI:Tl is used as a fluorescent material by way of example.

The vapor deposition method may be performed in the usual manner. For example, under the environment with a vacuum degree of 0.01 to 10 Pa, CsI:Tl is heated and evaporated by means of resistance heating crucibles to which electric power is applied. Thus, CsI:Tl is deposited on the support substrate 12A whose temperature is set at a room temperature (20° C.) to 300° C.

When a crystal phase of CsI:Tl is formed on the support substrate 12A by the vapor deposition method, comparatively small-diameter spherical crystals or an aggregate thereof is formed in the beginning. When at least one of the conditions, that is, the degree of vacuum or the temperature of the support substrate 12A is then changed, the columnar portion 34 can be formed continuously after the non-columnar portion 36A is formed. That is, after the spherical crystals are deposited to have a predetermined thickness, the degree of vacuum and/or the temperature of the support substrate 12A are increased so that the columnar crystals can be grown up.

Then, in the step of forming the non-columnar portion 36A, the non-columnar portion 36A is deposited with the degree of vacuum being changed. Thus, an uneven thickness distribution is given to the non-columnar portion 36A. When the degree of vacuum is changed, the melting state of CsI:Tl is changed, and it takes time to stabilize the melting state. Due to continuous deposition during the unstable melting state, an uneven thickness distribution can be given to the non-columnar portion 36A.

In the aforementioned manner, the scintillator 18A can be manufactured efficiently and easily. In addition, according to the manufacturing method, there is another advantage that scintillators of various specifications can be manufactured easily in conformity of their designs when the degree of vacuum or the temperature of the support substrate is controlled in the film formation of the scintillator 18A.

As described above, in the radiological image detection apparatus 1, the scintillator 18A is provided in the recess portion 140 so that the distance between each photoelectric conversion element 26 and the scintillator 18A can be shortened to improve the image sharpness. The support substrate 12A used for deposition supports the scintillator 18A (18B) as it is. The support substrate 12A and the reception substrate 14 are fixed through the first adhesive portion 13A. Thus, the problem about the shock resistance caused by increase in size of the radiological image detection apparatus 1 can be solved. In addition, since the scintillator 18A is deposited directly on the support substrate 12A, the adhesive agent between the scintillator 18A and the bottom surface 141a (of the thin plate portion 141) of the recess portion 140 can be dispensed with. Thus, the image sharpness can be improved. Further, even when only the scintillator 18A is damaged, the radiological image detection apparatus can be used as it is again if only the scintillator 18A is replaced. Thus, the reworkability can be also improved. In addition, the first adhesive portion 13A is formed out of a dismantlable adhesive agent. Therefore, even when only the scintillator 18A is damaged, the radiological image detection apparatus can be used as it is again if only the scintillator 18A is replaced. Thus, the reworkability can be improved. In addition, the side surface of the scintillator 18A and the side surface 142a of the thick plate portion 142 are fixed (bonded) through the second adhesive portion 13B so as to improve the shock resistance while preventing the scintillator 18A from needlessly shaking in the reception substrate 14. In addition, the adhesive agent used as the second adhesive portion 13B is a dismantlable adhesive agent. Therefore, even when only the scintillator 18A is damaged, the radiological image detection apparatus can be used as it is again if only the scintillator 18A is replaced. Thus, the reworkability can be improved.

In the radiological image detection apparatus 1, the support substrate 12A does not have to be a deposition substrate. In this case, GOS (Gd₂O₂S:Tb) or the like may be used as the fluorescent material forming the scintillator 18A.

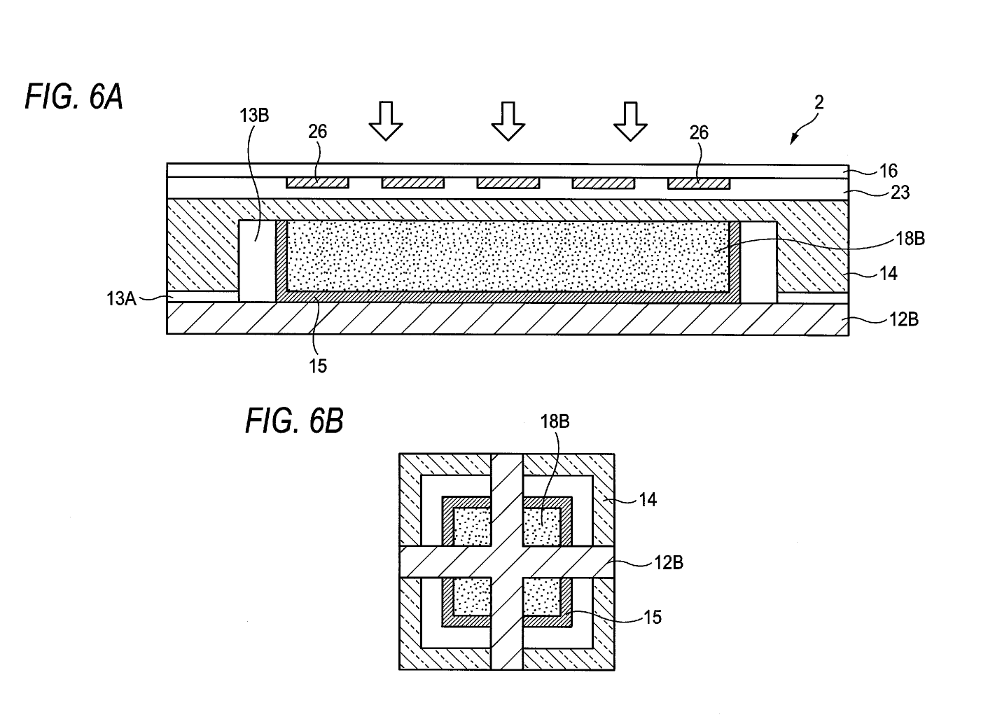

FIGS. 6A-6B are views schematically showing the configuration of another example of the radiological image detection apparatus in FIG. 1. Parts referred to by the same numerals as those in FIG. 1 have already been described so that the description thereof will be omitted here.

A radiological image detection apparatus 2 in this example is different from the aforementioned radiological image detection apparatus 1 at the point that a scintillator 18B is deposited directly on the reception substrate 14. On this occasion, a reinforcing plate 12B supports the scintillator 18B from an opposite side (from below) to the radiation entrance side. Thus, the scintillator 18B is held between the reception substrate 14 and the reinforcing plate 12B.

The reinforcing plate 12B is preferably limited to required minimum from the point of view of reduction in the total weight of the radiological image detection apparatus 2. For example, the reinforcing plate 12B may be provided like a cruciform as shown in FIG. 6B. When the reinforcing plate 12B is provided in a cruciate shape, the reception substrate 14 can be also prevented from being deformed.

When the reinforcing plate 12B is provided in the manner of required minimum, there is a fear of invasion of external moisture. Thus, the side surface of the scintillator 18B may be covered with a protective film 15 of parylene or the like.

To avoid the invasion of external moisture as much as possible, the reinforcing plate 12B may close the opening of the recess portion 140 of the reception substrate 14 in the same manner as in the radiological image detection apparatus 1. The reinforcing plate 12B provided in the whole surface of the recess portion 140 may be formed out of an aluminum plate or the like so that an optical reflection function can be included in the reinforcing plate 12B.

In addition, the configuration of the scintillator 18B is preferred as a scintillator for use in the radiological image detection apparatus 1. This is because the scintillator 18B is deposited directly on the reception substrate 14. In this case, the non-columnar portion 36A is located on the radiation entrance side. In the same manner, the non-columnar portion 36A is located on the radiation entrance side also in FIG. 3A in order to secure the adhesion.

Since each of the aforementioned radiological image detection apparatuses can detect a radiological image with high sensitivity and high definition, it can be incorporated and used in various systems such as an X-ray imaging system for medical diagnosis purpose such as mammography, which system is required to detect a sharp image with a low dose of radiation. For example, the radiological image detection apparatus is applicable to an industrial X-ray imaging system for nondestructive inspection, or a system for detecting particle rays (α-rays, β-rays, γ-rays) other than electromagnetic waves. The radiological image detection apparatus has a wide range of applications.

Description will be made below on materials that can be used for each constituent of the radiological image detection apparatus 1 and the radiological image detection apparatus 2.

### [Photoelectric Conversion Element]

Inorganic semiconductor materials such as amorphous silicon are often used for the photoconductive layer of the aforementioned photoelectric conversion elements 26. For example, any OPC (Organic Photoelectric Conversion) material disclosed in JP-A-2009-32854 may be used. A film (hereinafter referred to as OPC film) formed out of the OPC material can be used as the photoconductive layer 20. The OPC film contains an organic photoelectric conversion material, which absorbs light emitted from a phosphor layer and generates electric charges in accordance with the absorbed light. Such an OPC film containing an organic photoelectric conversion material has a sharp absorption spectrum in a visible light range. Thus, electromagnetic waves other than light emitted from the phosphor layer are hardly absorbed by the OPC film, but noise generated by radiation such as X-rays absorbed by the OPC film can be suppressed effectively.

It is preferable that the absorption peak wavelength of the organic photoelectric conversion material forming the OPC film is closer to the peak wavelength of light emitted by the phosphor layer in order to most efficiently absorb the light emitted by the phosphor layer. Ideally the absorption peak wavelength of the organic photoelectric conversion material agrees with the peak wavelength of the light emitted by the phosphor layer. However, the light emitted by the phosphor layer can be absorbed satisfactorily if the difference between the absorption peak wavelength of the organic photoelectric conversion material and the peak wavelength of the light emitted by the phosphor layer is small. Specifically, the difference between the absorption peak wavelength of the organic photoelectric conversion material and the peak wavelength of the light emitted by the phosphor layer in response to radiation is preferably not larger than 10 nm, more preferably not larger than 5 nm.

Examples of the organic photoelectric conversion material that can satisfy the conditions include arylidene-based organic compounds, quinacridone-based organic compounds, and phthalocyanine-based organic compounds. For example, the absorption peak wavelength of quinacridone in a visible light range is 560 nm. When quinacridone is used as the organic photoelectric conversion material and CsI(Tl) is used as the material of the phosphor layer, the aforementioned difference between the aforementioned peak wavelengths can be therefore set within 5 nm so that the amount of electric charges generated in the OPC film can be increased substantially to the maximum.

At least a part of an organic layer provided between the bias electrode and the charge collection electrode can be formed out of an OPC film. More specifically, the organic layer can be formed out of a stack or a mixture of a portion for absorbing electromagnetic waves, a photoelectric conversion portion, an electron transport portion, an electron hole transport portion, an electron blocking portion, an electron hole blocking portion, a crystallization prevention portion, electrodes, interlayer contact improvement portions, etc.

Preferably the organic layer contains an organic p-type compound or an organic n-type compound. An organic p-type semiconductor (compound) is a donor-type organic semiconductor (compound) as chiefly represented by an electron hole transport organic compound, meaning an organic compound having characteristic to easily donate electrons. More in detail, of two organic materials used in contact with each other, one with lower ionization potential is called the donor-type organic compound. Therefore, any organic compound may be used as the donor-type organic compound as long as the organic compound having characteristic to donate electrons. Examples of the donor-type organic compound that can be used include a triarylamine compound, a benzidine compound, a pyrazoline compound, a styrylamine compound, a hydrazone compound, a triphenylmethane compound, a carbazole compound, a polysilane compound, a thiophene compound, a phthalocyanine compound, a cyanine compound, a merocyanine compound, an oxonol compound, a polyamine compound, an indole compound, a pyrrole compound, a pyrazole compound, a polyarylene compound, a fused aromatic carbocyclic compound (naphthalene derivative, anthracene derivative, phenanthrene derivative, tetracene derivative, pyrene derivative, perylene derivative, fluoranthene derivative), a metal complex having a nitrogen-containing heterocyclic compound as a ligand, etc. The donor-type organic semiconductor is not limited thereto but any organic compound having lower ionization potential than the organic compound used as an n-type (acceptor-type) compound may be used as the donor-type organic semiconductor.

The n-type organic semiconductor (compound) is an acceptor-type organic semiconductor (compound) as chiefly represented by an electron transport organic compound, meaning an organic compound having characteristic to easily accept electrons. More specifically, when two organic compounds are used in contact with each other, one of the two organic compounds with higher electron affinity is the acceptor-type organic compound. Therefore, any organic compound may be used as the acceptor-type organic compound as long as the organic compound having characteristic to accept electrons. Examples thereof include a fused aromatic carbocyclic compound (naphthalene derivative, anthracene derivative, phenanthrene derivative, tetracene derivative, pyrene derivative, perylene derivative, fluoranthene derivative), a 5- to 7-membered heterocyclic compound containing a nitrogen atom, an oxygen atom or a sulfur atom (e.g. pyridine, pyrazine, pyrimidine, pyridazine, triazine, quinoline, quinoxaline, quinazoline, phthalazine, cinnoline, isoquinoline, pteridine, acridine, phenazine, phenanthroline, tetrazole, pyrazole, imidazole, thiazole, oxazole, indazole, benzimidazole, benzotriazole, benzoxazole, benzothiazole, carbazole, purine, triazolopyridazine, triazolopyrimidine, tetrazaindene, oxadiazole, imidazopyridine, pyralidine, pyrrolopyridine, thiadiazolopyridine, dibenzazepine, tribenzazepine etc.), a polyarylene compound, a fluorene compound, a cyclopentadiene compound, a silyl compound, and a metal complex having a nitrogen-containing heterocyclic compound as a ligand. The acceptor-type organic semiconductor is not limited thereto. Any organic compound may be used as the acceptor-type organic semiconductor as long as the organic compound has higher electron affinity than the organic compound used as the donor-type organic compound.

As for p-type organic dye or n-type organic dye, any known dye may be used. Preferred examples thereof include cyanine dyes, styryl dyes, hemicyanine dyes, merocyanine dyes (including zero-methine merocyanine (simple merocyanine)), trinuclear merocyanine dyes, tetranuclear merocyanine dyes, rhodacyanine dyes, complex cyanine dyes, complex merocyanine dyes, alopolar dyes, oxonol dyes, hemioxonol dyes, squarylium dyes, croconium dyes, azamethine dyes, coumarin dyes, arylidene dyes, anthraquinone dyes, triphenylmethane dyes, azo dyes, azomethine dyes, spiro compounds, metallocene dyes, fluorenone dyes, flugide dyes, perylene dyes, phenazine dyes, phenothiazine dyes, quinone dyes, indigo dyes, diphenylmethane dyes, polyene dyes, acridine dyes, acridinone dyes, diphenylamine dyes, quinacridone dyes, quinophthalone dyes, phenoxazine dyes, phthaloperylene dyes, porphyrin dyes, chlorophyll dyes, phthalocyanine dyes, metal complex dyes, and fused aromatic carbocyclic dyes (naphthalene derivative, anthracene derivative, phenanthrene derivative, tetracene derivative, pyrene derivative, perylene derivative, fluoranthene derivative).

A photoelectric conversion film (photosensitive layer) which has a layer of a p-type semiconductor and a layer of an n-type semiconductor between a pair of electrodes and at least one of the p-type semiconductor and the n-type semiconductor is an organic semiconductor and in which a bulk heterojunction structure layer including the p-type semiconductor and the n-type semiconductor is provided as an intermediate layer between those semiconductor layers may be used preferably. The bulk heterojunction structure layer included in the photoelectric conversion film can cover the defect that the carrier diffusion length of the organic layer is short. Thus, the photoelectric conversion efficiency can be improved. The bulk heterojunction structure has been described in detail in JP-A-2005-303266.

It is preferable that the photoelectric conversion film is thicker in view of absorption of light from the phosphor layer. The photoelectric conversion film is preferably not thinner than 30 nm and not thicker than 300 nm, more preferably not thinner than 50 nm and not thicker than 250 nm, particularly more preferably not thinner than 80 nm and not thicker than 200 nm in consideration of the ratio which does make any contribution to separation of electric charges.

As for any other configuration about the aforementioned OPC film, for example, refer to description in JP-A-2009-32854.

### [Switching Device]

Although inorganic semiconductor materials such as amorphous silicon are often used for the active layer of the switching devices 28, organic materials may be used as disclosed in JP-A-2009-212389. Any type of structure may be used as organic TFT but a field effect transistor (FET) structure is the most preferable. In the FET structure, a gate electrode is provided partially on an upper surface of an insulating substrate, and an insulator layer is provided to cover the electrode and touch the substrate in the other portion than the electrode. Further, a semiconductor active layer is provided on an upper surface of the insulator layer, and a transparent source electrode and a transparent drain electrode are disposed partially on the upper surface of the semiconductor active layer and at a distance from each other. This configuration is called a top contact type device. A bottom contact type device in which the source electrode and the drain electrode are disposed under the semiconductor active layer may be also used preferably. In addition, a vertical transistor structure in which a carrier flows in the thickness direction of an organic semiconductor film may be used.

### (Active Layer)

Organic semiconductor materials mentioned herein are organic materials showing properties as semiconductors. Examples of the organic semiconductor materials include p-type organic semiconductor materials (or referred to as p-type materials simply or as electron hole transport materials) which conduct electron holes (holes) as carriers, and n-type organic semiconductor materials (or referred to as n-type materials simply or as electron transport materials) which conduct electrons as carriers, in the same manner as semiconductors made of inorganic materials. Of the organic semiconductor materials, lots of p-type materials generally show better properties. In addition, p-type transistors are generally more excellent in operating stability as transistors under the atmosphere. Therefore, description here will be made on a p-type organic semiconductor material.

One of properties of organic thin film transistors is a carrier mobility (also referred to as mobility simply) μ which indicates the mobility of a carrier in an organic semiconductor layer. Mobility varies in accordance with applications, but higher mobility is generally preferred. The mobility is preferably not lower than 1.0*10⁻⁷ cm²/Vs, more preferably not lower than 1.0*10⁻⁶ cm²/Vs, further preferably not lower than 1.0*10⁻⁵ cm²/Vs. The mobility can be obtained by properties or TOF (Time Of Flight) measurement when the field effect transistor (FET) device is manufactured.

The p-type organic semiconductor material may be either a low molecular weight material or a high molecular weight material, but preferably a low molecular weight material. Lots of molecular weight materials show excellent properties due to easiness in high purification because various refining methods such as sublimation refining, recrystallization, column chromatography, etc. can be applied, or due to easiness in formation of a highly ordered crystal structure because they have a fixed molecular structure. The molecular weight of the low molecular weight material is preferably not lower than 100 and not higher than 5,000, more preferably not lower than 150 and not higher than 3,000, further more preferably not lower than 200 and not higher than 2,000.

A phthalocyanine compound or a naphthalocyanine compound can be exemplified as a p-type organic semiconductor material. A specific example thereof will be shown below. M represents a metal atom, Bu represents a butyl group, Pr represents a propyl group, Et represents an ethyl group, and Ph represents a phenyl group.

```
[Chemical 1]
  Compound 1 to 15
  Compound 16 to 20
```

| Compound | M | R | n | R′ | R″ |
|---|---|---|---|---|---|
| 1 | Si | OSi(n-Bu)₃ | 2 | H | H |
| 2 | Si | OSi(i-Pr)₃ | 2 | H | H |
| 3 | Si | OSi(OEt)₃ | 2 | H | H |
| 4 | Si | OSiPh₃ | 2 | H | H |
| 5 | Si | O(n-C₈H₁₇) | 2 | H | H |
| 7 | Ge | OSi(n-Bu)₃ | 2 | H | H |
| 8 | Sn | OSi(n-Bu)₃ | 2 | H | H |
| 9 | Al | OSi(n-C₆H₁₃)₃ | 1 | H | H |
| 10 | Ga | OSi(n-C₆H₁₃)₃ | 1 | H | H |
| 11 | Cu | — | — | O(n-Bu) | H |
| 12 | Ni | — | — | O(n-Bu) | H |
| 13 | Zn | — | — | H | t-Bu |
| 14 | V═O | — | — | H | t-Bu |
| 15 | H₂ | — | — | H | t-Bu |
| 16 | Si | OSiEt₃ | 2 | — | — |
| 17 | Ge | OSiEt₃ | 2 | — | — |
| 18 | Sn | OSiEt₃ | 2 | — | — |
| 19 | Al | OSiEt₃ | 1 | — | — |
| 20 | Ga | OSiEt₃ | 1 | — | — |

### (Constituents of Switching Device Other Than Active Layer)

The material forming the gate electrode, the source electrode or the drain electrode is not limited particularly if it has required electric conductivity. Examples thereof include transparent electrically conductive oxides such as ITO (indium-doped tin oxide), IZO (indium-doped zinc oxide), SnO₂, ATO (antimony-doped tin oxide), ZnO, AZO (aluminum-doped zinc oxide), GZO (gallium-doped zinc oxide), TiO₂, FTO (fluorine-doped tin oxide), etc., transparent electrically conductive polymers such as PEDOT/PSS (poly(3,4-ethylenedioxythiophene)/polystyrenesulfonate), carbon materials such as carbon nanotube, etc. Those electrode materials may be formed into films, for example, by a vacuum deposition method, sputtering, a solution application method, etc.

The material for use as the insulating layer is not limited particularly as long as it has required insulating effect. Examples thereof include inorganic materials such as silicon dioxide, silicon nitride, alumina, etc., and organic materials such as polyester, (PEN (polyethylene naphthalate), PET (polyethylene terephthalate) etc.), polycarbonate, polyimide, polyamide, polyacrylate, epoxy resin, polyparaxylylene resin, novolak resin, PVA (polyvinyl alcohol), PS (polystyrene), etc. Those insulating film materials may be formed into films, for example, by a vacuum deposition method, sputtering, a solution application method, etc.

For example, amorphous oxide disclosed in JP-A-2010-186860 may be used for the active layer of the switching devices 28. Here description will be made on an amorphous oxide containing active layer of an FET transistor disclosed in JP-A-2010-186860. The active layer serves as a channel layer of the FET transistor where electrons or holes can move.

The active layer has a configuration containing an amorphous oxide semiconductor. The amorphous oxide semiconductor can be formed into a film at a low temperature. Thus, the amorphous oxide semiconductor can be formed preferably on a flexible substrate. The amorphous oxide semiconductor used for the active layer is preferably amorphous oxide containing at least one kind of element selected from a group consisting of In, Sn, Zn and Cd, more preferably amorphous oxide containing at least one kind of element selected from a group consisting of In, Sn and Zn, further preferably amorphous oxide containing at least one kind of element selected from a group consisting of In and Zn.

Specific examples of the amorphous oxide used for the active layer include In₂O₃, ZnO, SnO₂, CdO, Indium-Zinc-Oxide (IZO), Indium-Tin-Oxide (ITO), Gallium-Zinc-Oxide (GZO), Indium-Gallium-Oxide (IGO), and Indium-Gallium-Zinc-Oxide (IGZO).

It is preferable that a vapor phase film formation method targeting at a polycrystal sinter of the oxide semiconductor is used as a method for forming the active layer. Of vapor phase film formation methods, a sputtering method or a pulse laser deposition (PLD) method is preferred. Further, the sputtering method is preferred in view from mass productivity. For example, the active layer is formed by an RF magnetron sputtering deposition method with a controlled degree of vacuum and a controlled flow rate of oxygen.

The thus formed active layer is confirmed to be an amorphous film by a known X-ray diffraction method. The composition ratio of the active layer is obtained by an RBS (Rutherford Backscattering Spectrometry) method.

In addition, the electric conductivity of the active layer is preferably lower than 10² Scm⁻¹ and not lower than 10⁻⁴ Scm⁻¹, more preferably lower than 10² Scm⁻¹ and not lower than 10⁻¹ Scm⁻¹. Examples of the method for adjusting the electric conductivity of the active layer include an adjusting method using oxygen defect, an adjusting method using a composition ratio, an adjusting method using impurities, and an adjusting method using an oxide semiconductor material, as known.

As for any other configuration about the aforementioned amorphous oxide, for example, refer to description in JP-A-2010-186860.

### [Reception Substrate]

Examples of the material as the reception substrate 14 include glass, quartz, plastic film, etc. Examples of the plastic film include films or the like, made from polyethylene terephthalate (PET), polyethylene naphthalate (PEN), polyether sulfone (PES), polyether imide, polyetheretherketone, polyphenylene sulfide, polyalylate, polyimide, polycarbonate (PC), cellulose triacetate (TAC), cellulose acetate propionate (CAP), etc. In addition, any organic or inorganic filler may be contained in those plastic films. A flexible substrate formed out of aramid, bionanofiber, or the like, having properties, such as flexibility with low thermal expansion and high strength, that cannot be obtained by existing glass or plastic, may be used preferably as the reception substrate 14.

### (Aramid)

An aramid material has high heat resistance showing a glass transition temperature of 315° C., high rigidity showing a Young's modulus of 10 GPa, and high dimensional stability showing a thermal expansion coefficient of −3 to 5 ppm/° C. Therefore, when a film made from aramid is used, it is possible to easily form a high-quality film for a semiconductor layer, as compared with the case where a general resin film is used. In addition, due to the high heat resistance of the aramid material, an electrode material can be cured at a high temperature to have low resistance. Further, it is also possible to deal with automatic mounting with ICs, including a solder reflow step. Furthermore, since the aramid material has a thermal expansion coefficient close to that of ITO (indium tin oxide), a gas barrier film or a glass substrate, warp after manufacturing is small. In addition, cracking hardly occurs. Here, it is preferable to use a halogen-free (in conformity with the requirements of JPCA-ES01-2003) aramid material containing no halogens, in view of reduction of environmental load.

The aramid film may be laminated with a glass substrate or a PET substrate, or may be pasted onto a housing of a device.

High intermolecular cohesion (hydrogen bonding force) of aramid leads to low solubility to a solvent. When the problem of the low solubility is solved by molecular design, an aramid material easily formed into a colorless and transparent thin film can be used preferably. Due to molecular design for controlling the order of monomer units and the substituent species and position on an aromatic ring, easy formation with good solubility can be obtained with the molecular structure kept in a bar-like shape with high linearity leading to high rigidity or dimensional stability of the aramid material. Due to the molecular design, halogen-free can be also achieved.

In addition, an aramid material having an optimized characteristic in an in-plane direction of a film can be used preferably. Tensional conditions are controlled in each step of solution casting, vertical drawing and horizontal drawing in accordance with the strength of the aramid film which varies constantly during casting. Due to the control of the tensional conditions, the in-plane characteristic of the aramid film which has a bar-like molecular structure with high linearity leading to easy occurrence of anisotropic physicality can be balanced.

Specifically, in the solution casting step, the drying rate of the solvent is controlled to make the in-plane thickness-direction physicality isotropic and optimize the strength of the film including the solvent and the peel strength from a casting drum. In the vertical drawing step, the drawing conditions are controlled precisely in accordance with the film strength varying constantly during drawing and the residual amount of the solvent. In the horizontal drawing, the horizontal drawing conditions are controlled in accordance with a change in film strength varying due to heating and controlled to relax the residual stress of the film. By use of such an aramid material, the problem that the aramid film after casting may be curled.

In each of the contrivance for the easiness of casting and the contrivance for the balance of the film in-plane characteristic, the bar-like molecular structure with high linearity peculiar to aramid can be kept to keep the thermal expansion coefficient low. When the drawing conditions during film formation are changed, the thermal expansion coefficient can be reduced further.

### (Bionanofiber)

Components sufficiently small with respect to the wavelength of light produce no scattering of the light. Accordingly, nanofibers can be used as reinforcement for a transparent and flexible resin material. Of the nanofibers, a composite material (occasionally referred to as bionanofiber) of bacterial cellulose and transparent resin can be used preferably. The bacterial cellulose is produced by bacteria (Acetobacter Xylinum). The bacterial cellulose has a cellulose microfibril bundle width of 50 nm, which is about 1/10 as large as the wavelength of visible light. In addition, the bacterial cellulose is characterized by high strength, high elasticity and low thermal expansion.

When a bacterial cellulose sheet is impregnated with transparent resin such as acrylic resin or epoxy resin and hardened, transparent bionanofiber showing a light transmittance of about 90% in a wavelength of 500 nm while having a high fiber ratio of about 60 to 70% can be obtained. By the bionanofiber, a thermal expansion coefficient (about 3 to 7 ppm) as low as that of silicon crystal, strength (about 460 MPa) as high as that of steel, and high elasticity (about 30 GPa) can be obtained.

As for any configuration about the aforementioned bionanofiber, for example, refer to description in JP-A-2008-34556.

### [Flattening Layer and Adhesive Layer]

The material of the flattening layer 23 and the adhesive layer serving as a resin layer for optically coupling the scintillator 18A (18B) with the photoelectric conversion elements 26 is not limited particularly as long as the material allows fluorescence of the scintillator 18A (18B) to reach the photoelectric conversion elements 26 without being attenuated. Resin such as polyimide or parylene may be used as the flattening layer 23. It is preferable to use polyimide with good film-forming properties. Examples of the adhesive layer include thermoplastic resin, UV-curable adhesive, heat curing adhesive, room temperature setting adhesive, double-faced adhesive sheet, etc. In order to prevent the sharpness of an image from being lowered, it is preferable to use an adhesive agent of low-viscosity epoxy resin because the adhesive agent can form a sufficiently thin adhesive layer with respect to the pixel size.

As described above, the following technical ideas are disclosed herein.

(1) A radiological image detection apparatus includes: a substrate in which a recess portion having a bottom portion including at least the whole of a radiological imaging region is formed; a phosphor which contains a fluorescent material emitting fluorescence when exposed to radiation and which is provided in the recess portion of the substrate; a group of photoelectric conversion elements which are provided on an opposite side to the recess portion provided with the phosphor and which photoelectrically convert the fluorescence emitted from the phosphor; a support which supports the phosphor; and a fixing portion which fixes the support and the substrate. The photoelectric conversion elements, the substrate, the phosphor and the support are arranged in ascending order of distance from a radiation entrance side.

(2) The radiological image detection apparatus may further include: a filler which is charged between a side surface of the phosphor and a side surface of the recess portion of the substrate and which has a shock absorbing property.

(3) In the radiological image detection apparatus, the phosphor may be in direct and close contact with a bottom surface of the recess portion of the substrate.

(4) In the radiological image detection apparatus, the fixing portion may be formed out of a dismantlable adhesive agent.

(5) In the radiological image detection apparatus, the filler may be a dismantlable adhesive agent.

(6) In the radiological image detection apparatus, the phosphor may be formed out of crystals of the fluorescent material deposited on a deposition substrate, and the support may be the deposition substrate.

(7) In the radiological image detection apparatus, the phosphor may be formed out of crystals of the fluorescent material deposited on the substrate, and the support may be a reinforcing plate which holds the phosphor between itself and the substrate.

(8) In the radiological image detection apparatus, the phosphor may have a columnar portion which is formed out of a group of columnar crystals in which crystals of the fluorescent material have grown into columnar shapes.

(9) In the radiological image detection apparatus, the phosphor may further include a first non-columnar portion which is interposed between the columnar portion and the support.

(10) In the radiological image detection apparatus, the phosphor may further include a second non-columnar portion which is interposed between the columnar portion and the substrate.

(11) In the radiological image detection apparatus, an opening of the recess portion of the substrate may be closed by the support.

(12) In the radiological image detection apparatus, the phosphor may be formed of fluorescent material of CsI:Tl.

(13) In the radiological image detection apparatus, the substrate substantially may enclose the phosphor completely.

(14) In the radiological image detection apparatus, the first non-columnar portion may be not smaller than 5 μm and not larger than 125 nm.

(15) In the radiological image detection apparatus, the filler may be provided to surround only a side surface of the phosphor.

(16) In the radiological image detection apparatus, an end of the columnar portion may be opposed to a thin plate portion of the substrate.

(17) The radiological image detection apparatus may further include: an optically transparent shock absorption layer which is provided between the columnar portion and the thin plate portion of the substrate.

(18) In the radiological image detection apparatus, the shock absorption layer may be formed of transparent silicone rubber.

(19) In the radiological image detection apparatus, a void ratio of the second non-columnar portion may be substantially zero.

(20) In the radiological image detection apparatus, the reinforcing plate may be provided in a cruciate shape.

What is claimed is:

1. A radiological image detection apparatus comprising:
a substrate in which a recess portion having a bottom portion including at least the whole of a radiological imaging region is formed;
a phosphor which contains a fluorescent material emitting fluorescence when exposed to radiation and which is provided in the recess portion of the substrate;
a group of photoelectric conversion elements which are provided on an opposite side to the recess portion provided with the phosphor and which photoelectrically convert the fluorescence emitted from the phosphor;
a support which supports the phosphor; and
a fixing portion which fixes the support and the substrate; wherein:
the photoelectric conversion elements, the substrate, the phosphor and the support are arranged in ascending order of distance from a radiation entrance side.

2. The radiological image detection apparatus according to claim 1, further comprising:
a filler which is charged between a side surface of the phosphor and a side surface of the recess portion of the substrate and which has a shock absorbing property.

3. The radiological image detection apparatus according to claim 1, wherein:
the phosphor is in direct and close contact with a bottom surface of the recess portion of the substrate.

4. The radiological image detection apparatus according to claim 1, wherein:
the fixing portion is formed out of a dismantlable adhesive agent.

5. The radiological image detection apparatus according to claim 2, wherein:
the filler is a dismantlable adhesive agent.

6. The radiological image detection apparatus according to claim 1, wherein:
the phosphor is formed out of crystals of the fluorescent material deposited on a deposition substrate; and
the support is the deposition substrate.

7. The radiological image detection apparatus according to claim 1, wherein:
the phosphor is formed out of crystals of the fluorescent material deposited on the substrate; and
the support is a reinforcing plate which holds the phosphor between itself and the substrate.

8. The radiological image detection apparatus according to claim 1, wherein:
the phosphor has a columnar portion which is formed out of a group of columnar crystals in which crystals of the fluorescent material have grown into columnar shapes.

9. The radiological image detection apparatus according to claim 8, wherein:
the phosphor further includes a first non-columnar portion which is interposed between the columnar portion and the support.

10. The radiological image detection apparatus according to claim 8, wherein:
the phosphor further includes a second non-columnar portion which is interposed between the columnar portion and the substrate.

11. The radiological image detection apparatus according to claim 1, wherein:
an opening of the recess portion of the substrate is closed by the support.

12. The radiological image detection apparatus according to claim 1, wherein:
the phosphor is formed of fluorescent material of CsI:Tl.

13. The radiological image detection apparatus according to claim 1, wherein:
the substrate substantially encloses the phosphor completely.

14. The radiological image detection apparatus according to claim 9, wherein:
the first non-columnar portion is not smaller than 5 μm and not larger than 125 μm.

15. The radiological image detection apparatus according to claim 2, wherein:
the filler is provided to surround only a side surface of the phosphor.

16. The radiological image detection apparatus according to claim 8, wherein:
an end of the columnar portion is opposed to a thin plate portion of the substrate.

17. The radiological image detection apparatus according to claim 16, further comprising:
an optically transparent shock absorption layer which is provided between the columnar portion and the thin plate portion of the substrate.

18. The radiological image detection apparatus according to claim 17, wherein:
the shock absorption layer is formed of transparent silicone rubber.

19. The radiological image detection apparatus according to claim 10, wherein:
a void ratio of the second non-columnar portion is substantially zero.

20. The radiological image detection apparatus according to claim 7, wherein:
the reinforcing plate is provided in a cruciate shape.
